(19) United States
(12) Patent Application Publication
(10) Pub. No.: US 2025/0012753 A1
(43) Pub. Date: Jan. 9, 2025

(54) ELECTRODE

(71) Applicant: NITTO DENKO CORPORATION, Ibaraki-shi, Osaka (JP)

(72) Inventors: Yuna SUGA, Ibaraki-shi, Osaka (JP); Motoki HAISHI, Ibaraki-shi, Osaka (JP)

(21) Appl. No.: 18/696,709

(22) PCT Filed: Sep. 9, 2022
(86) PCT No.: PCT/JP2022/033886

§ 371 Date: Mar. 28, 2024

(30) Foreign Application Priority Data
Sep. 30, 2021 (JP) 2021-160995

(51) Int. Cl. G01N 27/327

(52) U.S. Cl. CPC G01N 27/3271

(57) ABSTRACT

An electrode includes a substrate, a conductive carbon layer, and a metal layer in sequence toward one side in the thickness direction. The conductive carbon layer includes sp² bonded atoms and sp³ bonded atoms. The metal layer is disposed on one surface of the conductive carbon layer in the thickness direction. The area ratio of the metal layer on the one surface of the conductive carbon layer is 95% or less.

### TECHNICAL FIELD

The present invention relates to an electrode.

### BACKGROUND ART

There is a known electrode including a carbon substrate and a noble metal layer covering one surface of the carbon substrate in a sea island state (for example, see Patent document 1 below). The electrode of Patent document 1 is used to detect a physiologically active substance including glucose.

### CITATION LIST

### Patent Document

Patent Document 1: Japanese Unexamined Patent Publication No. 2004-156928

### SUMMARY OF THE INVENTION

### Problem to be Solved by the Invention

Depending on the use and purpose of the electrode, a high signal-to-background ratio is required. The signal-to-background ratio is a ratio of signal intensity to background (noise) intensity. However, in the electrode described in Patent Document 1, there are limitations on the increase in signal-to-background ratio.

The present invention provides an electrode with a high signal-to-background ratio.

### Means for Solving the Problem

The present invention [1] includes an electrode including: a substrate; a conductive carbon layer; and a metal layer in sequence toward one side in a thickness direction, wherein the conductive carbon layer includes sp² bonded atoms and sp³ bonded atoms, wherein the metal layer is disposed on one surface of the conductive carbon layer in the thickness direction, and wherein an area ratio of the metal layer on the one surface of the conductive carbon layer is 95% or less.

The present invention [2] includes the electrode described in the above-described [1], wherein the metal layer is a gold layer.

The present invention [3] includes the electrode described in the above-described [1] or [2], wherein the metal layer has an island structure.

The present invention [4] includes the electrode described in any one of the above-described [1] to [3], wherein a ratio of the number of sp³ bonded atoms to a sum of the number of sp³ bonded atoms and the number of sp² bonded atoms is 0.30 or more.

The present invention [5] includes the electrode described in any one of the above-described [1] to [4], wherein the area ratio is 70% or more.

The present invention [6] includes the electrode described in any one of the above-described [1] to [5], further including: a metal underlying layer, wherein the substrate, the metal underlying layer, the conductive carbon layer, and the metal layer are disposed in sequence toward one side in the thickness direction.

The present invention [7] includes the electrode described in any one of the above-described [1] to [6], wherein the substrate is a flexible film.

### Effects of the Invention

An electrode of the present invention has a high signal-to-background ratio.

### BRIEF DESCRIPTION OF THE DRAWINGS

FIG. 1 is a cross-sectional view of one embodiment of the electrode of the present invention.

### DESCRIPTION OF THE EMBODIMENT

### 1. One Embodiment of Electrode

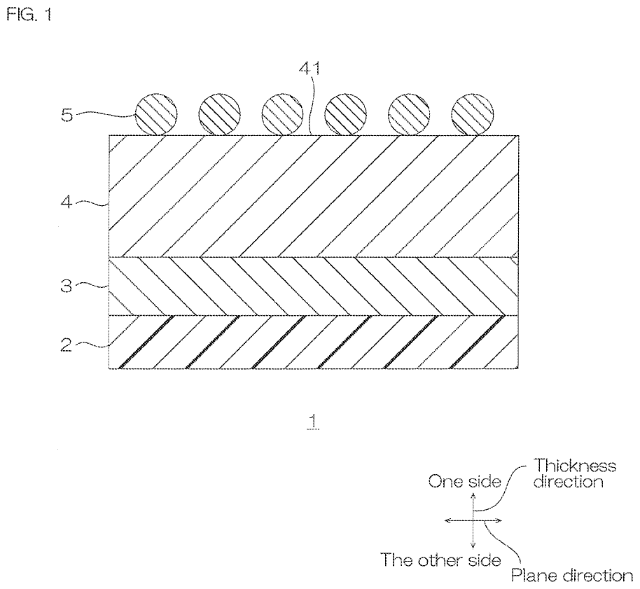

One Embodiment of the electrode of the present invention is described with reference to FIG. 1. The electrode 1 has a thickness. The electrode 1 extends in a plane direction. The plane direction is orthogonal to a thickness direction. Specifically, the electrode 1 has the shape of a sheet. The electrode 1 includes a substrate 2, a metal underlying layer 3, a conductive carbon layer 4, and a metal layer 5 in sequence toward one side in the thickness direction. In the present embodiment, the electrode 1 preferably includes only the substrate 2, the metal underlying layer 3, the conductive carbon layer 4, and the metal layer 5.

### 1.1 Substrate 2

The substrate 2 forms the other surface in the thickness direction of the electrode 1. Examples of the material of the substrate 2 include an inorganic material and an organic material. Examples of the inorganic material include silicon and glass. Examples of the organic material include polyester, polyolefin, acryl, and polycarbonate. Examples of the polyester include polyethylene terephthalate (PET) and polyethylene naphthalate.

As the material of the substrate 2, preferably an organic material is used, more preferably polyester is used, and even more preferably PET is used. When the material of the substrate 2 is an organic material, the substrate 2 is a flexible film. When the substrate 2 is a flexible film, the electrode 1 has excellent handleability. The substrate 2 has a thickness of, for example, 2 μm or more, preferably 20 μm or more, and, for example, 1000 μm or less, preferably 500 μm or less.

### 1.2 Metal Underlying Layer 3

The metal underlying layer 3 is disposed on one surface of the substrate 2 in the thickness direction. Specifically, the metal underlying layer 3 is in contact with the one surface of the substrate 2 in the thickness direction. The metal underlying layer 3 extends in the plane direction. Examples of the material of the metal underlying layer 3 include the Group 4 metal elements (titanium and zirconium), the Group 5 metal elements (vanadium, niobium, and tantalum), the Group 6 metal elements (chromium, molybdenum, and tungsten), the Group 7 metal elements (manganese), the Group 8 metal elements (iron), the Group 9 metal elements (cobalt), the Group 10 metal elements (nickel and platinum), the Group 11 metal elements (gold), the Group 12 metal elements (zinc), the Group 13 metal elements (aluminum and gallium), and the Group 14 metal elements (germanium and tin). These materials can be used singly or in combination. As the material of the metal underlying layer 3, preferably titanium is used. The metal underlying layer 3 has a thickness of 50 nm or less, preferably 35 nm or less, and, for example, 1 nm or more, preferably 3 nm or more.

### 1.3 Conductive Carbon Layer 4

The conductive carbon layer 4 is disposed on one surface of the metal underlying layer 3 in the thickness direction. Specifically, the conductive carbon layer 4 is in contact with the one surface of the metal underlying layer 3 in the thickness direction. The conductive carbon layer 4 extends in the plane direction. The conductive carbon layer 4 has electrical conductivity.

In the present invention, the conductive carbon layer 4 includes sp² bonded atoms and sp³ bonded atoms. Specifically, the conductive carbon layer 4 includes carbon having an sp² bond and carbon having an sp³ bond. In other words, the conductive carbon layer 4 has a graphite structure and a diamond structure. In this manner, the conductive carbon layer 4 has excellent electrical conductivity and can increase the signal-to-background ratio.

In comparison, when the conductive carbon layer 4 includes sp² bonded atoms but does not include sp³ bonded atoms, the signal-to-background ratio cannot sufficiently be increased.

In the conductive carbon layer 4, the ratio (sp³/sp³+sp²) of the number of sp³ bonded atoms to the sum of the number of sp³ bonded atoms and the number of sp² bonded atoms is not limited. In the conductive carbon layer 4, the ratio (sp³/sp³+sp²) of the number of sp³ bonded atoms to the sum of the number of sp³ bonded atoms and the number of sp² bonded atoms is, for example, 0.05 or more, preferably 0.10 or more, more preferably 0.15 or more, even more preferably 0.20 or more, particularly preferably 0.25 or more, most preferably 0.30 or more, and, for example, 0.90 or less, preferably 0.75 or less, more preferably 0.50 or less, even more preferably 0.40 or less.

When the ratio (sp³/sp³+sp²) of the number of sp³ bonded atoms to the sum of the number of sp³ bonded atoms and the number of sp² bonded atoms is the above-described lower limit or more, the signal-to-background ratio can be increased. It is assumed that this is because due to the decrease in the amount of functional group in the one surface 41 of the conductive carbon layer 4, the background current decreases.

The ratio (sp³/sp³+sp²) of the number of the sp³ bonded atoms is measured using X-ray photoelectron spectroscopy.

The conductive carbon layer 4 is allowed to contain a trace of inevitable impurities other than oxygen.

The conductive carbon layer 4 has a thickness of, for example, 0.1 nm or more, preferably 1 nm or more, and 100 nm or less, preferably, 50 nm or less.

### 1.4 Metal Layer 5

The metal layer 5 is disposed on a part of the one surface 41 of the conductive carbon layer 4 in the thickness direction. The metal layer 5 forms one surface of the electrode 1 in the thickness direction together with the above-described conductive carbon layer 4. Furthermore, the metal layer 5 exposes the remainder of the one surface 41 of the conductive carbon layer 4. The metal layer 5 forms the one surface of the electrode 1 in the thickness direction together with the conductive carbon layer 4.

In the present invention, the area ratio of the metal layer 5 on the one surface 41 of the conductive carbon layer 4 is 95% or less.

On the other hand, when the area ratio of the metal layer 5 on the one surface 41 of the conductive carbon layer 4 is more than 95%, the metal layer 5 has a continuous film structure continuous in the plane direction, and the electrode 1 cannot achieve a high signal-to-background ratio.

In contrast, in the present embodiment, the area ratio of the metal layer 5 on the one surface 41 of the conductive carbon layer 4 is 95% or less. Thus, the metal layer 5 has an island structure, and the electrode 1 can achieve a high signal-to-background ratio.

Examples of the material of the metal layer 5 include gold, copper, platinum, iron, tin, and silver. As the material of the metal layer 5, preferably gold is used. When the material of the metal layer 5 is gold, the metal layer 5 is a gold layer. When the metal layer 5 is a gold layer, the signal-to-background ratio can further be increased.

The area ratio of the metal layer 5 on the one surface 41 of the conductive carbon layer 4 is preferably 94% or less, more preferably 93% or less. Furthermore, the area ratio of the metal layer 5 on the one surface 41 of the conductive carbon layer 4 is, for example, 10% or more, preferably more than 50%, more preferably 70% or more, even more preferably 75% or more, particularly preferably 90% or more.

When the area ratio of the metal layer 5 on the one surface 41 of the conductive carbon layer 4 is the above-described upper limit or less and lower limit or more, the electrode 1 can achieve a higher signal-to-background ratio.

The area ratio of the metal layer 5 on the one surface 41 of the conductive carbon layer 4 is calculated from the phase image captured in Tapping Mode measurements with an atomic force microscope. The method of measuring the area ratio of the metal layer 5 on the one surface 41 of the conductive carbon layer 4 is detailed in Examples below.

The method of setting the area ratio of the metal layer 5 on the one surface 41 of the conductive carbon layer 4 into the above-described range is not limited. For example, the sputtering (described below) time is adjusted.

The above-described metal layer 5 has, for example, an island structure when being viewed from one side in the thickness direction. Specifically, in the metal layer 5, a large number of spherical gold particles independent from each other are dispersed. In this case, the electrode 1 has a sea island structure when being viewed from one side in the thickness direction.

The metal layer 5 has a thickness of, for example, 0.05 nm or more, preferably 0.1 nm or more, more preferably 0.3 nm or more, even more preferably 0.7 nm or more, particularly preferably 1 nm or more, most preferably 1.5 nm or more. Furthermore, the thickness is preferably 2 nm or more and, for example, 5 nm or less.

The electrode 1 has a thickness of, for example, 2 μm or more, preferably 20 μm or more, and, for example, 1000 μm or less, preferably 500 μm or less.

### 1.5 Method of Producing Electrode 1

Next, a method of producing the electrode 1 is described. In this method, first, the substrate 2 is prepared, and subsequently the metal underlying layer 3, the conductive carbon layer 4, and the metal layer 5 are formed in sequence toward one side in the thickness direction relative to the substrate 2.

To form the metal underlying layer 3 on the one surface of the substrate 2 in the thickness direction, for example, a dry method, preferably sputtering is used. In sputtering, for example, the above-described metal is used as a target. The target has a surface. In sputtering, for example, a noble gas, preferably argon is used as a sputtering gas. The electricity (power) applied to the target and the pressure of the sputtering gas are appropriately set. Specifically, the power density applied to the target is, for example, 1 W/cm² or more, preferably 2 W/cm² or more, and, for example, 5 W/cm² or less.

To form the conductive carbon layer 4 on the one surface of the metal underlying layer 3 in the thickness direction, for example, a dry method, preferably sputtering is used. In sputtering, for example, carbon is used as a target. The target has a surface. In sputtering, for example, a noble gas, preferably argon is used as a sputtering gas. The electricity applied to the target and the pressure of the sputtering gas are appropriately set. Specifically, the power density applied to the target is, for example, 1 W/cm² or more, preferably 2 W/cm² or more, and, for example, 5 W/cm² or less.

To form the metal layer 5 on a part of the one surface 41 of the conductive carbon layer 4 in the thickness direction, for example, a dry method, preferably sputtering is used. In sputtering, for example, the above-described metal (preferably gold) is used as a target. The target has a surface. In sputtering, for example, a noble gas, preferably argon is used as a sputtering gas. The pressure of the sputtering gas is appropriately set. The power density applied to the target is, for example, 1 W/cm² or less, preferably 0.5 W/cm² or less, more preferably 0.3 W/cm² or less, even more preferably 0.2 W/cm² or less, and, for example, 0.01 W/cm² or more, preferably 0.05 W/cm² or more. The ratio of the power density applied to the target of the metal (preferably gold) to the power density applied to the target of the material (preferably gold) of the metal layer 5 is, for example, 0.0001 or more, preferably 0.001 or more, and, for example, 0.1 or less, preferably 0.05 or less.

### 1.7 Uses of Electrode 1

Next, the uses of the electrode 1 are described. The electrode 1 can be used as various electrodes, preferably as an electrode for an electrochemical measurement to carry out an electrochemical measurement method, specifically, as a working electrode (working pole) to carry out cyclic voltammetry (CV), and as a working electrode (working pole) to carry out square-wave voltammetry (SWV), anodic stripping voltammetry (ASV), or amperometry.

Particularly, the electrode 1 is in a high signal-to-background ratio when a physiologically active substance is measured. Examples of the physiologically active substance include blood sugar. Blood sugar includes glucose.

When the electrode 1 is used as an electrode for measuring glucose, a known enzyme is disposed on the one surface of the electrode 1 in the thickness direction in a known method to prepare an enzyme-modified electrode 10.

### 2. Operations and Effects of One Embodiment

In the electrode 1, the conductive carbon layer 4 includes sp² bonded atoms and sp³ bonded atoms. The area ratio of the metal layer 5 on the one surface 41 of the conductive carbon layer 4 is 95% or less. Thus, the signal-to-background ratio is high.

When the metal layer 5 is a gold layer, the signal-to-background ratio is higher.

When the metal layer 5 has an island structure, the signal-to-background ratio is higher.

When the ratio of the number of sp³ bonded atoms to the sum of the number of sp³ bonded atoms and the number of sp² bonded atoms is 0.30 or more, the signal-to-background ratio is higher.

When the above-described area ratio is 70% or more, the signal-to-background ratio is higher.

In addition, the electrode 1 further includes a metal underlying layer 3, and thus has the effect of improving the adhesiveness of the conductive carbon layer 4 and the effect of suppressing the degassing from the substrate 2 when the material of the substrate 2 is polyester (specifically PET).

Furthermore, in the electrode 1, when the substrate 2 is a flexible film, excellent handleability is achieved.

### 3. Variations

In the variations, the same members and steps as in one embodiment are given the same numerical references, and the detailed descriptions thereof are omitted. Further, the variations can have the same operations and effects as those of one embodiment unless especially described otherwise. Furthermore, one embodiment and the variations can appropriately be combined.

Although not shown, two metal underlying layers 3, two conductive carbon layers 4, and two metal layers 5 may be included. Specifically, the electrode 1 of this variation includes a metal layer 5, a conductive carbon layer 4, a metal underlying layer 3, a substrate 2, a metal underlying layer 3, a conductive carbon layer 4, and a metal layer 5 in sequence toward one side in the thickness direction.

Although not shown, the electrode 1 does not include a metal underlying layer 3. In this variation, the conductive carbon layer 4 is disposed on the one surface of the substrate 2 in the thickness direction.

### EXAMPLES

Next, the present invention is more specifically described with reference to Examples and Comparative Examples. The present invention is not limited to Examples and Comparative Examples in any way. The specific numeral values used in the description below, such as blending ratios (content ratios), physical property values, and parameters, can be replaced with the corresponding blending ratios (content ratios), physical property values, and parameters in the above-described “DESCRIPTION OF THE EMBODIMENT”, including the upper limit values (numeral values defined with “or less” or “less than”) or the lower limit values (numeral values defined with “or more” or “more than”).

### Examples 1 to 5 and Comparative Example 1

A substrate (flexible film) 2 made of PET was prepared.

On a substrate 2, using a DC magnetron sputtering device, a metal underlying layer 3 made of titanium and having a thickness of 7 nm, a conductive carbon layer 4 having a thickness of 10 nm, and a metal layer 5 having a thickness of 0.5 to 10 nm were formed in sequence toward one side in the thickness direction.

The conditions for sputtering each of the metal underlying layer 3, the conductive carbon layer 4, and the metal layer 5 are shown in Table 1. The area ratio of the metal layer 5 on the one surface 41 of the conductive carbon layer 4 was adjusted with sputtering time.

In the conductive carbon layer 4 of each of Examples 1 to 4 and Comparative Example 1, the ratio (sp³/sp³+sp²) of the number of sp³ bonded atoms was 0.30. On the other hand, in the conductive carbon layer 4 of Example 5, the ratio (sp³/sp³+sp²) of the number of sp³ bonded atoms was 0.35. The above-described ratios were measured using an X-ray photoelectron spectroscopy (XPS, SHIMADZU CORPORATION).

In this manner, an electrode 1 including the substrate 2, the metal underlying layer 3, the conductive carbon layer 4, and the metal layer 5 in sequence toward one side in the thickness direction was produced.

### Comparative Example 2

In the same manner as Example 1, an electrode 1 was produced. However, the electrode 1 did not include a metal layer 5.

### Comparative Example 3

Using HOPG (highly oriented pyrolytic graphite, manufactured by Momentive Technologies, grade ZYA) in which the ratio (sp³/sp³+sp²) of the number of sp³ bonded atoms was 0.00 as a substrate, a metal layer 5 (a gold layer) having a thickness of 0.5 nm was formed on one surface of the substrate by sputtering.

### Comparative Example 4

Using HOPG (highly oriented pyrolytic graphite, manufactured by Momentive Technologies, grade ZYA) in which the ratio (sp³/sp³+sp²) of the number of sp³ bonded atoms was 0.00 as a substrate, a metal layer 5 (a gold layer) having a thickness of 1 nm was formed on one surface of the substrate by sputtering.

### Evaluations

For the electrode 1 of each of Examples and Comparative Examples, the following physical properties were evaluated. The results are shown in Table 3.

### (1) Area Ratio of Metal Layer 5 on One Surface 41 of Conductive Carbon Layer 4

The area ratio of the metal layer 5 on the one surface 41 of the conductive carbon layer 4 was calculated from the phase image captured in Tapping Mode measurements of an atomic force microscope (AFM, Bruker). The range of the image was a minimum phase difference to a maximum phase difference. The light parts in the phase image were assumed as the metal layer 5 while the dark parts was assumed as the conductive carbon layer 4, and the image was binarized by brightness using image analysis software (WinROOF). The distribution of brightness of the image was obtained and the parts having a brightness of 70 percent or more of the maximum degree of brightness of the light parts were assumed as a gold region and the parts darker than them were assumed as a conductive carbon region, thereby binarizing the image. The area ratio of the metal layer 5 on the one surface 41 of the conductive carbon layer 4 was calculated from the binarized image using the software.

(2) Measurement of Signal-to-background Ratio in Glucose Response

### (2-1) Enzyme Modification

First, 0.8 mg of glucose dehydrogenase, 1.5 μL of a 4 wt % bovine serum albumin aqueous solution, 1.2 μL of a 1% glutaraldehyde aqueous solution, and 0.3 μL of a 0.05M potassium phosphate buffer solution (pH 6.5) were mixed, thereby preparing an enzyme solution.

Next, an insulating tape having a 2-mm diameter hole was bonded to one surface of the electrode 1 in the thickness direction, thereby producing an electrode 1 with a known area. The above-described enzyme solution was dropped onto the electrode 1, and then the electrode 1 was stored in a refrigerator at 3° C. for a night or more to prepare an enzyme-modified carbon electrode 10.

### (2-2) Measurement of Currents in Response to Glucose

First, an electrolytic solution to which KCl was added so as to become 1 M and a 1000 mg/dL glucose solution were mixed to a 100 mM potassium ferrocyanide solution and a 0.05 M phosphoric acid buffer (pH 6.5) according to the formulations of Table 2 to prepare each a 0 mg/dL glucose solution and a 600 mg/dL glucose solution.

Next, the enzyme-modified carbon electrode 10 was used as a working electrode, and connected together with a reference electrode (Ag/AgCl) and a counter electrode (Pt) to a potentiostat (IVIUM Technologies, pocketSTAT) to produce an electrochemical measurement system including the electrodes. Next, 1 mL of the glucose solution at each of the concentrations was developed on the enzyme-modified carbon electrode 10 for one minute. Thereafter, cyclic voltammetry (CV) measurement was carried out for the reference electrode of the electrochemical measurement system of each of the glucose solutions in a potential sweep range of −0.2 to 0.8 V at a scan rate of 0.1 V/sec. From the results of the CV measurement, the value of the current value at a glucose concentration of 600 mg/dl at 0.3 V to the current value at a glucose concentration of 0 mg/dl was determined as a signal-to-background ratio.

### (3) Measurement of Thickness of Metal Layer 5

The thickness of the metal layer 5 (gold layer) was measured using an X-ray fluorescence spectrometer (XRF, Rigaku). The intensity of X-ray fluorescence (Au-Lα ray) of the gold was measured. From the measured intensity, the thickness of the gold layer was calculated using the following formula.

$$Thickness of Gold Layer = ( Intensity of X - ray fluorescence of Gold - 0.0055 ) / 0.1579$$

TABLE 1

| | Metal | Conductive | |
|---|---|---|---|
| | underlying | carbon | Metal |
| | layer | layer | layer |
| Target material | Ti | Carbon | Au |
| Pressure of argon gas (Pa) | 0.2 | 0.4 | 0.3 |
| Power density applied to | 3.33 | 3.33 | 0.13 |
| target (W/cm²) | | | |

TABLE 2

| | | | 1000 | 0.05M potassium |
|---|---|---|---|---|
| | Glucose | | mg/dL | phosphate |
| | concentration | 100 mM | Glucose | buffer solution + |
| | [mg/dL] | FeCN | solution | KCl(pH6.5) |
| Parts by mass | 0 | 50 | 0 | 950 |
| for | | | | |
| formulation | 600 | 50 | 600 | 350 |

TABLE 3

| | | | | Signal-to- |
|---|---|---|---|---|
| | | | | background |
| | | | | Ratio at |
| | $\frac{{sp}^{3}}{{sp}^{3} + {sp}^{2}}$ | Area ratio of metal layer (%) | Thickness of metal layer (nm) | glucose concentration of 600 mg/dl |
| Example 1 | 0.30 | 62 | 0.98 | 16 |
| Example 2 | 0.30 | 71 | 0.50 | 36 |
| Example 3 | 0.30 | 83 | 1.96 | 47 |
| Example 4 | 0.30 | 93 | 2.96 | 131 |
| Example 5 | 0.35 | 84 | 0.98 | 138 |
| Comp. Ex. 1 | 0.30 | 96 | 10.00 | 9 |
| Comp. Ex. 2 | 0.30 | 0 | 0.00 | 10 |
| Comp. Ex. 3 | 0.00 | 70 | 0.98 | 25 |
| Comp. Ex. 4 | 0.00 | 92 | 0.50 | 46 |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The electrode for electrochemical measurement is used, for example, for a working electrode.

### DESCRIPTION OF REFERENCE NUMERALS

1 electrode
2 substrate
3 metal underlying layer
4 conductive carbon layer
41 one surface of conductive carbon layer
5 metal layer

1. An electrode comprising: a substrate; a conductive carbon layer; and a metal layer in sequence toward one side in a thickness direction,
wherein the conductive carbon layer includes sp² bonded atoms and sp³ bonded atoms,
wherein the metal layer is disposed on one surface of the conductive carbon layer in the thickness direction, and
wherein an area ratio of the metal layer on the one surface of the conductive carbon layer is 95% or less.

2. The electrode according to claim 1, wherein the metal layer is a gold layer.

3. The electrode according to claim 1, wherein the metal layer has an island structure.

4. The electrode according to claim 1, wherein a ratio of the number of sp³ bonded atoms to a sum of the number of sp³ bonded atoms and the number of sp² bonded atoms is 0.30 or more.

5. The electrode according to claim 1, wherein the area ratio is 70% or more.

6. The electrode according to claim 1, further comprising:
a metal underlying layer,
wherein the substrate, the metal underlying layer, the conductive carbon layer, and the metal layer are disposed in sequence toward one side in the thickness direction.

7. The electrode according to claim 1, wherein the substrate is a flexible film.
